(19) United States
(12) Patent Application Publication
(10) Pub. No.: US 2023/0306538 A1
(43) Pub. Date: Sep. 28, 2023

(54) SYSTEM AND METHOD FOR PROCESSING CHANGES TO ITINERARIES

(71) Applicant: Amgine Technologies (US), Inc., Dover, DE (US)

(72) Inventors: Warren Stableford, Burlington (CA); Peter Sweeney, Kitchener (CA); Bryan Fernandez, Mississauga (CA)

(21) Appl. No.: 18/190,353

(22) Filed: Mar. 27, 2023

Related U.S. Application Data
(60) Provisional application No. 63/324,422, filed on Mar. 28, 2022.

(51) Int. Cl. G06Q 50/14; G06Q 10/02

(52) U.S. Cl. CPC G06Q 50/14; G06Q 10/025

(57) ABSTRACT

Systems and methods for processing changes to travel itineraries are provided. A system can comprise a database, a scheduler, and an optimizer. The database stores travel itineraries, traveler preferences, and itinerary change parameters. The scheduler exchanges information with travel supply networks and is operable to receive a travel itinerary, receive related travel itineraries, and optionally search the database for the related travel itineraries. The optimizer is operable to evaluate travel itinerary change tolerance parameters associated with the travel itinerary based on the traveler preferences, the itinerary change parameters, and the related travel itineraries; generate an optimized set of itinerary change tolerance parameters based on the evaluated itinerary change tolerance parameters and an optimization goal; and store the optimized set of itinerary change tolerance parameters for updating the travel itinerary.

### CROSS-REFERENCE TO RELATED APPLICATION

This application claims priority from U.S. provisional patent application No. 63/324,422 filed on Mar. 28, 2022, which is incorporated herein by reference in its entirety.

### FIELD

Various embodiments are described herein that generally relate to systems and methods for processing changes to travel itineraries.

### BACKGROUND

The following paragraphs are provided by way of background to the present disclosure. They are not, however, an admission that anything discussed therein is prior art or part of the knowledge of persons skilled in the art.

Travelers sometimes need to or want to make changes to their travel reservations. However, it can be difficult to change existing travel itineraries. For example, itineraries often combine multiple types of content, such as flights, hotels, and car rentals, which entail multiple reservation systems that must be accessed separately to affect changes to an itinerary.

Presently, travel agents, both human and computer-based, process these changes, working within very precise tolerances in tightly controlled environments. Once a change is initiated by the traveler, costs are calculated “to the penny” before being returned to the traveler for approval. Through a trial-and-error process, a traveler is consulted step-by-step as to whether a revised itinerary is acceptable. The agent manually queries the travel inventory to receive a validation or invalidation of the proposed itinerary as married against the original itinerary. Under this manual trial-and-error process, travelers must evaluate the new costs and the changes to the itinerary, often through a series of questions as each aspect of the itinerary is reconstructed sequentially. This imposes both inconvenience and the psychological burden of further deliberations, such as the perception that a higher price is unfair, or that lower-priced accommodations are of a lower quality. This process is put upon the agent and the traveler without any context for evaluating the changes.

There is a need for a system and method that addresses the challenges and/or shortcomings described above.

### SUMMARY OF VARIOUS EMBODIMENTS

Various embodiments of a system and method for processing changes to travel itineraries, and computer products for use therewith, are provided according to the teachings herein.

According to one aspect of the invention, there is disclosed a system for processing changes to travel itineraries comprising: at least one database for storing travel itineraries, traveler preferences, and itinerary change parameters; a scheduler for exchanging information with one or more travel supply networks and operable to: receive a travel itinerary; and receive related travel itineraries; and an optimizer operable to: evaluate travel itinerary change tolerance parameters associated with the travel itinerary based on the traveler preferences, the itinerary change parameters, and the related travel itineraries; generate an optimized set of itinerary change tolerance parameters based on the evaluated itinerary change tolerance parameters and an optimization goal; and store the optimized set of itinerary change tolerance parameters for updating the travel itinerary.

In at least one embodiment, the travel itinerary is responsive to a travel itinerary request.

In at least one embodiment, the traveler preferences comprise traveler itinerary change preferences.

In at least one embodiment, the scheduler is further operable to search the database for the related travel itineraries.

In at least one embodiment, the scheduler is operable to receive the related travel itineraries from the one or more travel supply networks.

In at least one embodiment, the scheduler is further operable to identify changed itineraries based on the optimized itinerary change tolerance parameters.

In at least one embodiment, the optimizer is operable to rank each itinerary in the set of changed itineraries based on the optimization goal.

In at least one embodiment, the scheduler is further operable to: receive a travel change request; retrieve the travel itinerary; retrieve the optimized set of itinerary change tolerance parameters associated with the travel itinerary; identify a set of changed itineraries associated with the itinerary change tolerance parameters, based on the travel change request; initiate a shopping call to the one or more travel supply networks to fulfill the set of changed itineraries; and identify available changed itineraries within the set of changed itineraries based on a response to the shopping call from the one or more travel supply networks.

In at least one embodiment, the optimizer is further operable to: rank the available changed itineraries based on at least one of: the travel change request or pricing information; transmit the ranked available changed itineraries; and receive a selection of a selected changed itinerary from the available changed itineraries.

In at least one embodiment, the scheduler is further operable to: determine a geographical region of the travel change request; determine if the geographical region is an allowable geographical region; and when the geographical region of the travel change request is not an allowable geographical region, transmit an alert indicating that the travel change request cannot be fulfilled.

In at least one embodiment, the scheduler is further operable to: retrieve at least one change implication associated with the geographical region from the database, the at least one change implication being selected from the group consisting of: a cancellation window, an exchange fee, an exchange penalty, and taxes.

In at least one embodiment, the scheduler is further operable to: determine if the travel change request is received prior to a start of a trip associated with the travel itinerary; and when the travel change request is not received prior to the start of the trip, transmit an alert indicating that the travel change request cannot be fulfilled.

In at least one embodiment, the scheduler is further operable to: determine if the travel change request is received within a predetermined allowable cancellation window; and when the travel change request is received within the predetermined allowable cancellation window, transmit a request to the one or more travel supply networks to cancel the travel itinerary.

In at least one embodiment, the optimizer is further operable to: determine a feasibility of travel itinerary changes based on the evaluated travel itinerary change tolerance parameters; and transmit a notification comprising at least one of: the feasibility of the travel itinerary changes, the travel itinerary change tolerance parameters, or the optimized set of travel itinerary change tolerance parameters.

In at least one embodiment, the optimized set of itinerary change tolerance parameters is associated with financial values stored in a credit accounting system.

In at least one embodiment, the scheduler is further operable to determine at least one financial implication of a travel itinerary change, based on the financial values.

In at least one embodiment, the travel itinerary is associated with a ticket record, rule category information, and ticketing process information.

In at least one embodiment, the ticket record comprises at least one of: a fare basis, a flight class, a price, or a penalty for changes.

In at least one embodiment, the rule category information comprises at least one of: date restrictions, time restrictions, rules relating to allowable changes based on fare bases, fare seasonality information, advance purchase information, a minimum stay, a maximum stay, stopover information, rules for combinability, blackout dates, data relating to surcharges, data relating to restrictions, ticket endorsement information, sale restrictions, a passenger type, a fare discount, fare rules, rules for voluntary changes to an itinerary, fare refundability rules, same day change rules, baggage information, combinability, ticket record fields, ticket endorsements, a fare tax, a fare ladder, a corporate contract ID, a tour code, tax information, a ticket designator code, or void rules.

In at least one embodiment, the ticketing process information comprises a ticket number, an airline code, a validation number, and a passenger type.

In at least one embodiment, the scheduler is further operable to determine the itinerary change parameters based on the travel itinerary.

In at least one embodiment, the optimization goal is a reduction in cost.

In at least one embodiment, the optimizer is operable to resolve an intersection of the itinerary change parameters, the traveler preferences, and the related itineraries to evaluate the itinerary change tolerance parameters.

In at least one embodiment, the traveler preferences comprise at least one of: a price preference, a preferred departure time, a preferred return time, a preferred class of service, a tolerance for changes in departure date, a tolerance for changes in departure time, a tolerance for changes in return date, or a tolerance for changes in return time.

According to another aspect of the invention, there is disclosed a method for processing changes to travel itineraries, the method comprising: receiving a travel itinerary; receiving related travel itineraries; evaluating travel itinerary change tolerance parameters associated with the travel itinerary based on traveler preferences, itinerary change parameters, and the related travel itineraries; generating an optimized set of itinerary change tolerance parameters based on the evaluated travel itinerary change tolerance parameters and an optimization goal; and storing the optimized set of itinerary change tolerance parameters for updating the travel itinerary.

In at least one embodiment, the travel itinerary is responsive to the travel itinerary request.

In at least one embodiment, the traveler preferences comprise traveler itinerary change preferences.

In at least one embodiment, the method further comprises searching a database for the related travel itineraries.

In at least one embodiment, the method further comprises receiving the related travel itineraries from one or more travel supply networks.

In at least one embodiment, generating the optimized set of itinerary change tolerance parameters comprises identifying changed itineraries associated with the optimized set of itinerary change tolerance parameters.

In at least one embodiment, the method further comprises ranking each itinerary in the set of changed itineraries based on the optimization goal.

In at least one embodiment, the method further comprises: receiving a travel change request; retrieving the travel itinerary; retrieving the optimized set of itinerary change tolerance parameters associated with the travel itinerary; identifying a set of changed itineraries based on the travel change request and the optimized set of itinerary change tolerance parameters; initiating a shopping call to one or more travel supply networks to fulfill the set of changed itineraries; and identifying available changed itineraries within the set of changed itineraries based on a response to the shopping call from the one or more travel supply networks.

In at least one embodiment, the method further comprises: ranking the available changed itineraries based on at least one of: the travel change request, a similarity to the travel itinerary, pricing information, change penalty information, or the travel preferences; transmitting the ranked available changed itineraries; and receiving a selection of a selected changed itinerary from the available changed itineraries.

In at least one embodiment, the method further comprises: determining a geographical region of the travel change request; determining if the geographical region is an allowable geographical region; and when the geographical region of the travel change request is not an allowable geographical region, transmitting an alert indicating that the travel change request cannot be fulfilled.

In at least one embodiment, the method further comprises: retrieving at least one change implication associated with the geographical region from the database, the at least one change implication being selected from the group consisting of: a cancellation window, an exchange fee, an exchange penalty, and taxes.

In at least one embodiment, the method further comprises: determining if the travel change request is received prior to a start of a trip associated with the travel itinerary; and when the travel change request is not received prior to the start of the trip, transmitting an alert indicating that the travel change request cannot be fulfilled.

In at least one embodiment, the method further comprises: determining if the travel change request is received within a predetermined allowable cancellation window; and when the travel change request is received within the predetermined allowable cancellation window, transmitting a request to the one or more travel supply networks to cancel the travel itinerary.

In at least one embodiment, the method further comprises: determining a feasibility of travel itinerary changes based on the evaluated travel itinerary change tolerance parameters; and transmitting a notification comprising at least one of: the feasibility of the travel itinerary changes, the travel itinerary change tolerance parameters, or the optimized set of travel itinerary change tolerance parameters.

In at least one embodiment, the optimized set of itinerary change tolerance parameters is associated with financial values stored in a credit accounting system.

In at least one embodiment, the method further comprises determining at least one financial implication of a travel itinerary change, based on the financial values.

In at least one embodiment, the travel itinerary is associated a ticket record, rule category information, and ticketing process information.

In at least one embodiment, the ticket record comprises at least one of: a fare basis, a flight class, a price, or a penalty for changes.

In at least one embodiment, the rule category information comprises at least one of: date restrictions, time restrictions, rules relating to allowable changes based on fare bases, fare seasonality information, advance purchase information, a minimum stay, a maximum stay, stopover information, rules for combinability, blackout dates, data relating to surcharges, data relating to restrictions, ticket endorsement information, sale restrictions, a passenger type, a fare discount, fare rules, rules for voluntary changes to an itinerary, fare refundability rules, same day change rules, baggage information, combinability, ticket record fields, ticket endorsements, a fare tax, a fare ladder, a corporate contract ID, a tour code, tax information, a ticket designator code, or void rules.

In at least one embodiment, the ticketing process information comprises a ticket number, an airline code, a validation number, and a passenger type.

In at least one embodiment, evaluating the travel itinerary change tolerance parameters comprises determining the travel itinerary change tolerance parameters based on the travel itinerary.

In at least one embodiment, the optimization goal is a reduction in cost.

In at least one embodiment, evaluating the itinerary change tolerance parameters comprises resolving an intersection of the itinerary change parameters, the traveler preferences, and the related itineraries.

In at least one embodiment, the traveler preferences comprise at least one of: a price preference, a preferred departure time, a preferred return time, a preferred class of service, a tolerance for changes in departure date, a tolerance for changes in departure time, a tolerance for changes in return date, or a tolerance for changes in return time.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1 shows a block diagram of an example embodiment of a travel network that includes a computer system for processing changes to an itinerary.

FIG. 2 shows a block diagram of an example embodiment of a computer system for processing changes to an itinerary.

FIG. 3 shows a block diagram of another example embodiment of a computer system for processing changes to an itinerary.

FIG. 4 shows an example graphical user interface of what may be presented to a user and used by the user to specify tolerances.

FIG. 5 shows a flowchart of an example embodiment of a method of processing a change request that may be incorporated in a travel itinerary change model.

FIG. 6 shows a diagram of an example optimization problem that may be solved by the system of FIG. 3.

FIG. 7 shows a flowchart of an example embodiment of a method for processing changes to an itinerary.

FIG. 8 shows a flowchart of an example method of capturing information by the system of FIG. 3.

FIGS. 9A-9C show flowcharts of another example embodiment of a method for processing an itinerary change request.

Further aspects and features of the example embodiments described herein will appear from the following description taken together with the accompanying drawings.

### DETAILED DESCRIPTION OF THE EMBODIMENTS

Various embodiments in accordance with the teachings herein will be described below to provide an example of at least one embodiment of the claimed subject matter. No embodiment described herein limits any claimed subject matter. The claimed subject matter is not limited to devices, systems, or methods having all of the features of any one of the devices, systems, or methods described below or to features common to multiple or all of the devices, systems, or methods described herein. It is possible that there may be a device, system, or method described herein that is not an embodiment of any claimed subject matter. Any subject matter that is described herein that is not claimed in this document may be the subject matter of another protective instrument, for example, a continuing patent application, and the applicants, inventors, or owners do not intend to abandon, disclaim, or dedicate to the public any such subject matter by its disclosure in this document.

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures, and components have not been described in detail so as not to obscure the embodiments described herein. Also, the description is not to be considered as limiting the scope of the embodiments described herein.

It should also be noted that the terms “coupled” or “coupling” as used herein can have several different meanings depending on the context in which these terms are used. For example, the terms coupled or coupling can have a mechanical or electrical connotation. For example, as used herein, the terms coupled or coupling can indicate that two elements or devices can be directly connected to one another or connected to one another through one or more intermediate elements or devices via an electrical signal, electrical connection, or a mechanical element depending on the particular context.

It should also be noted that, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be noted that terms of degree such as “substantially”, “about”, and “approximately” as used herein mean a reasonable amount of deviation of the modified term such that the end result is not significantly changed. These terms of degree may also be construed as including a deviation of the modified term, such as by 1%, 2%, 5%, or 10%, for example, if this deviation does not negate the meaning of the term it modifies.

Furthermore, the recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed, such as 1%, 2%, 5%, or 10%, for example.

It should also be noted that the use of the term “window” in conjunction with describing the operation of any system or method described herein is meant to be understood as describing a user interface for performing initialization, configuration, or other user operations.

The example embodiments of the devices, systems, or methods described in accordance with the teachings herein may be implemented as a combination of hardware and software. For example, the embodiments described herein may be implemented, at least in part, by using one or more computer programs, executing on one or more programmable devices comprising at least one processing element and at least one storage element (i.e., at least one volatile memory element and at least one non-volatile memory element). The hardware may comprise input devices including at least one of a touch screen, a keyboard, a mouse, buttons, keys, sliders, and the like, as well as one or more of a display, a printer, and the like depending on the implementation of the hardware.

It should also be noted that there may be some elements that are used to implement at least part of the embodiments described herein that may be implemented via software that is written in a high-level procedural language such as object-oriented programming. The program code may be written in C++, C#, JavaScript, Python, or any other suitable programming language and may comprise modules or classes, as is known to those skilled in object-oriented programming. Alternatively, or in addition thereto, some of these elements implemented via software may be written in assembly language, machine language, or firmware as needed. In either case, the language may be a compiled or interpreted language.

At least some of these software programs may be stored on a computer-readable medium such as, but not limited to, a ROM, a magnetic disk, an optical disc, a USB key, and the like that is readable by a device having a processor, an operating system, and the associated hardware and software that is necessary to implement the functionality of at least one of the embodiments described herein. The software program code, when read by the device, configures the device to operate in a new, specific, and predefined manner (e.g., as a specific-purpose computer) in order to perform at least one of the methods described herein.

At least some of the programs associated with the devices, systems, and methods of the embodiments described herein may be capable of being distributed in a computer program product comprising a computer-readable medium that bears computer usable instructions, such as program code, for one or more processing units. The medium may be provided in various forms, including non-transitory forms such as, but not limited to, one or more diskettes, compact disks, tapes, chips, and magnetic and electronic storage. In alternative embodiments, the medium may be transitory in nature such as, but not limited to, wire-line transmissions, satellite transmissions, internet transmissions (e.g., downloads), media, digital and analog signals, and the like. The computer-usable instructions may also be in various formats, including compiled and non-compiled code.

In accordance with the teachings herein, there are provided various embodiments for a system and method for (automatically) processing changes to travel itineraries, and computer products for use therewith. Often, in conventional travel booking systems, the information needed to efficiently make changes is lost in between the time when an itinerary is prepared and when a change to the existing itinerary is requested. For example, the range of parameters that defined the possible itineraries, as compared with the smaller set of parameters that comprised the initial itinerary, may be lost. This information loss is inefficient and costly, as it results in necessitating a new itinerary to be built every time a change to an existing itinerary is requested.

The embodiments provided herein (automatically) process itinerary changes by anticipating changes when the itinerary is first created, by capturing, storing, and processing information necessary to make changes to the itinerary. Anticipating changes on the front end of the process can decrease transactional interactions between travelers and travel suppliers when changes are eventually required.

At least one of the embodiments described herein can anticipate changes by storing itinerary information about the itinerary selected by the traveler and a model of future changes. For example, parameters specifying the range of tolerances that reconcile the travel request and the traveler's preferences within the set of potential travel itineraries associated with the travel request may be stored. This range of tolerances encodes a set of potential changes to the travel itinerary corresponding to a subset of all feasible itineraries and can be used to evaluate itineraries when a change is requested, such that when a travel itinerary change is requested, the entire range of feasible itineraries does not need to be reevaluated.

At least one of the embodiments described herein can alert the user of the system that a travel request is associated with a limited range of possible future changes or that no future changes to a travel itinerary are possible.

At least one of the embodiments described herein can provide to the user information about the feasibility of future changes, as well as the potential costs and/or limitations on future changes at the time the itinerary is created.

At least one of the embodiments described herein can automate the process of (automatically) processing changes, which can reduce the informational burden imposed on the traveler and the transactional costs associated with processing changes, increase convenience and efficiency for the traveler, and reduce operational complexities and sources of errors when intermediaries such as travel agents are involved.

At least one of the embodiments described herein can use state machines to represent the various states, events, decisions, and actions used to process changes to itineraries.

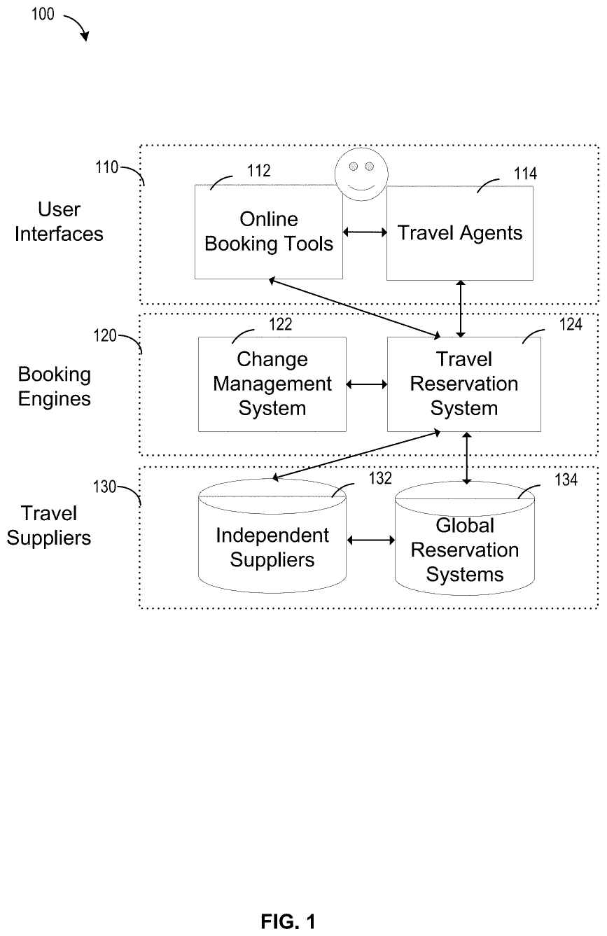

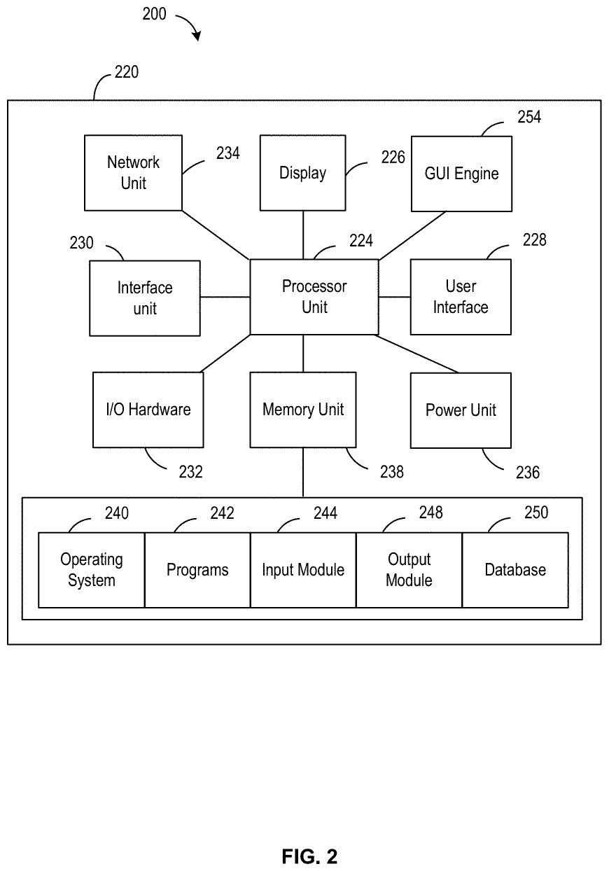

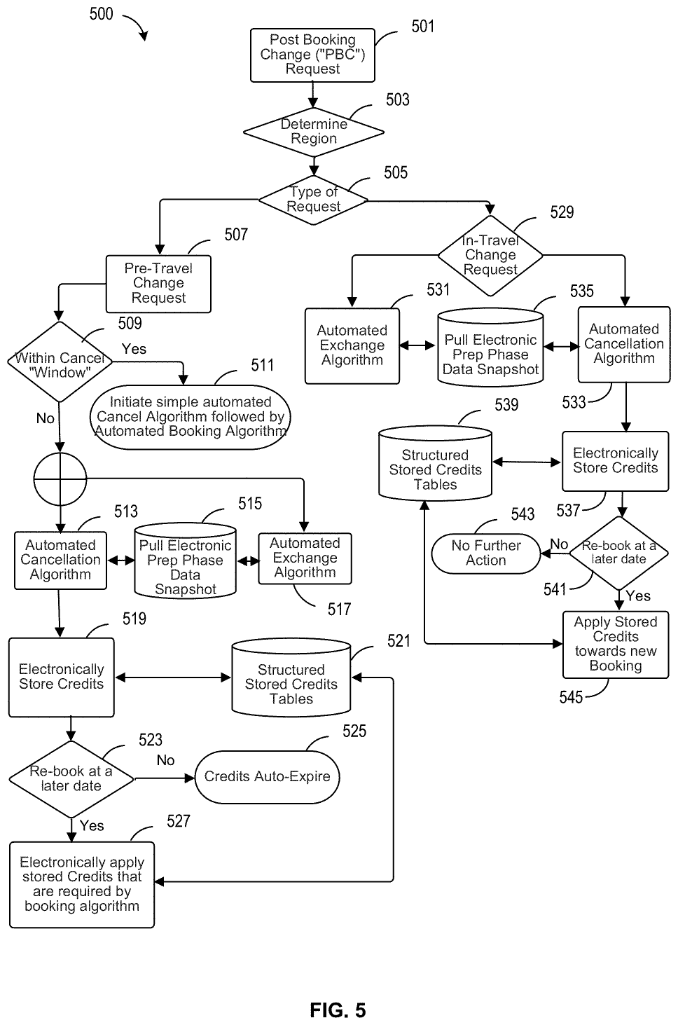

FIG. 1 describes a travel network and supply chain, FIGS. 2-4 and 6 describe system components that may be used by the various embodiments described herein for (automatically) processing travel itinerary changes, and FIGS. 5 and 7-9 describe example process flows that may be associated with the system components shown in FIGS. 2-4 and 6.

### Travel Industry Integration

Reference is first made to FIG. 1 showing a block diagram of an example embodiment of a travel network 100 that includes a change management system 122. The change management system 122 can be part of a booking engine 120 that includes the change management system 122 and a travel reservation system 124. The change management system 122 may be loosely coupled to the travel reservation system 124 and operate as a component of the travel reservation system 124. Alternatively, the change management system 122 may be tightly coupled to the travel reservation system 124 and accordingly be integrated within the travel reservation system 124. For example, each component of the travel reservation system 124 may be extended to incorporate proactive change management capabilities. The change management system 122 can interact with user interfaces 110 on the front end, and with travel suppliers 130 on the back end, via the travel reservation system 124.

User interfaces can include online booking tools (OBTs) 112 and reservation systems used by travel agents 114 and travel management companies (TMCs). OBTs 112 can include any type of self-service platform commonly used by travelers to book itineraries, such as the SAP Concur tool and the Deem tool. OBTs 112 can be in communication with travel agents 114. For example, travel agents 114 may have access to and use the administrative capabilities of OBTs 112 to review and service requests made by clients registered to an OBT.

Travel suppliers 130 can include independent suppliers 132, which supply travel content directly to the travel reservation system 124, for example, airline companies, car rental companies, and hotels, and/or global reservation systems (GDS) 134. Examples of GDS include Sabre, Amadeus, and the Travelport family. The independent suppliers 132 may be in communication with the GDS 134 and/or make application programming interfaces (API) available. In some cases, the independent suppliers 132 and the GDS 134 may communicate via command line interfaces.

These components may be integrated using APIs operating over internal and/or public networks. Some components may be provided internally over a private network. While FIG. 1 shows an example embodiment of a travel network, it will be appreciated that other components may be coupled to the network and that the existing components may be coupled or decoupled using various system designs and architectures. For example, a services-oriented architecture may be used, consisting of components providing microservices. Alternatively, or in addition, components may be deployed in a cloud-based serverless architecture.

### System Components

FIG. 2 shows a block diagram of an example embodiment of a computer system 200 for (automatically) processing changes to travel itineraries. The computer system 200 includes at least one server 220. The server 220 may, for example, communicate with a user device (or multiple user devices) wirelessly or over the Internet. The computer system 200 may be, for example, the particular hardware configuration for the change management system 122.

The user device may be a computing device that is operated by a user. The user device may be, for example, a smartphone, a smartwatch, a tablet computer, a laptop, a virtual reality (VR) device, or an augmented reality (AR) device. The user device may also be, for example, a combination of computing devices that operate together, such as a smartphone and a sensor. The user device may be configured to run an application (e.g., a mobile app) that communicates with other parts of the computer system 200, such as the server 220.

The server 220 may run on a single computer, including a processor unit 224, a display 226, a user interface 228, an interface unit 230, input/output (I/O) hardware 232, a network unit 234, a power unit 236, and a memory unit (also referred to as “data store”) 238. In other embodiments, the server 220 may have more or less components but generally function in a similar manner. For example, the server 220 may be implemented using more than one computing device.

The processor unit 224 may include a standard processor, such as the Intel Xeon processor, for example. Alternatively, there may be a plurality of processors that are used by the processor unit 224, and these processors may function in parallel and perform certain functions. The display 226 may be, but not limited to, a computer monitor or an LCD display such as that for a tablet device. The user interface 228 may be an Application Programming Interface (API) or a web-based application that is accessible via the network unit 234. The network unit 234 may be a standard network adapter such as an Ethernet or 802.11x adapter.

The processor unit 224 can also execute a graphical user interface (GUI) engine 254 that is used to generate various GUIs. The GUI engine 254 provides data according to a certain layout for each user interface and also receives data input or control inputs from a user. The GUI then uses the inputs from the user to change the data that is shown on the current user interface, or changes the operation of the server 220 which may include showing a different user interface.

The memory unit 238 may store the program instructions for an operating system 240, program code 242 for other applications, an input module 244, an output module 248, and a database 250. The database 250 may be, for example, a local database, an external database, a database on the cloud, multiple databases, or a combination thereof.

The programs 242 comprise program code that, when executed, configures the processor unit 224 to operate in a particular manner to implement various functions and tools for the computer system 200.

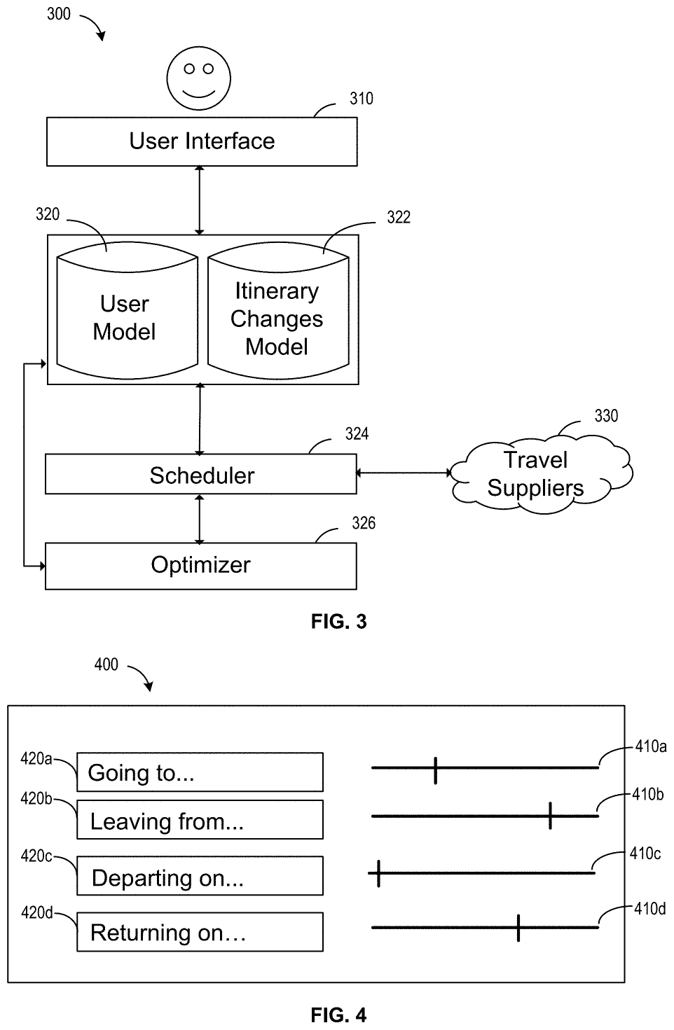

FIG. 3 shows a block diagram of another example embodiment of a system 300 for (automatically) processing changes to a travel itinerary. The system 300 includes a user interface 310, a user model database 320, an itinerary-changes model database 322, a scheduler 324, an optimizer 326, and a travel supply network 330. The travel supply network 330 can be analogous to the travel suppliers 130. The user interface 310 can be analogous to the user interfaces 110 and may be accessed or implemented by a user device.

### User Interface

The user interface 310 may incorporate forms used to solicit aspects of itinerary preferences from users, including, for example, in the case of a flight, a place of origin, a destination, and a time of travel. The user interface 310 may also receive interactions from the user. For example, the user may request a travel itinerary or a change to a travel itinerary via the user interface 310 and may approve or decline suggested changed itineraries via the user interface 310.

The system defined by the user model database 320, the itinerary-changes model database 322, the scheduler 324, and the optimizer 326 may be substantially similar to the change management system 122.

### User Model Database

The user model database 320 can include user profiles generated in accordance with a user model that captures information about the user, including, but not limited to, user preferences (which may also be referred to as “traveler preferences”) and tolerances with respect to travel itineraries and travel itinerary changes. For example, each user of the system 300 may be associated with a separate user profile. The user profiles may be generated by the system 300. Alternatively, user profiles may be constructed externally to the system 300 and accessible to the system 300 via the user model database 320, for example, through a common GDS profile data store. Preferences and tolerances with respect to travel itineraries can include conventional elements associated with travel itineraries typically included in user models as is commonly known by those skilled in the art, including, but not limited to, preferences with respect to price, a maximum number of layovers, a preferred hotel class, a preferred class of rental vehicles, a gas refill preference, a type of bed, a hotel room floor, a smoking preference, and a preferred flight class. Preferences and tolerances with respect to travel itineraries changes can include parameters including, but not limited to, a maximum price difference, a departure date or time flexibility, a return date or time flexibility and a car pick-up and drop-off flexibility.

The user model may be implemented using any combination of approaches and technologies, including, but not limited to, relational databases, graph databases, key/value stores, document databases, and search engine indices.

User preferences and tolerances with respect to travel itineraries may be at least in part specified by a user on a user device. For example, the user may use the user device to indicate preferences at the time of booking using a variety of input methods, for example, sliding scales, checkboxes, drop-down menus, or editable textboxes that may be provided on the user interface 310 of the user device. An example graphical user interface that may be used by a user device of system 300 to specify user preferences is shown in FIG. 4, which will be described in further detail below. User preferences and tolerances specified by the user via the user device may be persisted by the system 300, stored in the user model database 320, and/or applied to future reservations.

Alternatively, or in addition, preferences and tolerances may include external constraints. For example, the user model can include policy rules set by travel agents if the user is booking an itinerary through a travel agent and/or employer travel policy if the user is traveling on an employer-sanctioned trip. For example, travel agents may impose constraints on the maximum return date. Similarly, employers may impose restrictions on pricing, or on departure date and return date. A user's employer and the restrictions imposed by the employer may be stored in the user profile associated with the user. Alternatively, this information may be stored in a separate policy database that is associated with the user or a group of users and accessible by the system 300.

Alternatively, or in addition, the user model may capture standard preferences assumed by the system 300. For example, most travelers prefer fewer layovers. Accordingly, a preference for fewer layovers may be included in user profiles unless the user has indicated a contrary preference. When provided with similar options, travelers typically also prefer incurring fewer costs and, accordingly, user models can assume a preference for less costly options.

Alternatively, or in addition, preferences and tolerances captured by the user model may be derived through the user device's interactions with the system 300. For example, the user model may capture historical information about the user device's interactions with the system 300. For example, a consistent choice of departure flights in the morning may be an indication that the user associated with the user device prefers flying in the morning. Additionally, itinerary changes made to an itinerary may be indicative of the user's preferences. For example, if a user device consistently accepts a changed itinerary with a cost 5% superior to the original itinerary, the system may infer that the user associated with the user device has an at least +5% tolerance to changes in price. The user profile associated with the user may reflect these preferences. Alternatively, or in addition, preferences and tolerances and/or historical data may be obtained from external sources and accessed by the system 300.

The user model may be dynamic and may be adjusted over time as the user's preferences change and/or to more accurately capture the user's preferences. In at least one embodiment, statistical and/or machine learning models may be constructed to represent the user model. For example, a method of supervised learning may be applied to labeled training data derived from past itineraries. Alternatively, or in addition, a user model may be prepared manually as an initial model, with modifications applied to tailor the initial model to each user's individual preferences. Alternatively, or in addition, statistics such as the prevalence of travel choices may be applied to a set of past itineraries to derive an initial model composed of common preferences across all travelers.

Table 1 below shows example parameters that may be captured by a user model. For example, the traveler associated with the user model of Table 1 may tolerate a range of +/−10% on travel pricing, tolerate at most 1 stop for their flights, have a flexibility of +/−4 hours in departure time, a flexibility of +1 day on their return trip, and a flexibility of +4 h on their return time. For example, if the user's original return flight departs at 8 am, the user may tolerate returning the next day and may tolerate a return flight that departs between 8 am and 12 pm.

TABLE 1

| Itinerary Component | Parameters |
|---|---|
| Pricing | +/− 10% |
| Max Flight Stops | 1 |
| Departure Date Flexibility | 0 days |
| Return Date Flexibility | +1 day |
| Departure Time Flexibility | +/− 4 h |
| Return Time Flexibility | +4 h |

FIG. 4 shows an example embodiment of a graphical user interface 400 that may be used by the user device to specify user preferences and tolerances. Sliding scales 410a-410d may be used to specify tolerances with respect to, for example, a departure date, a departure time, a return date, a return time, a distance from the origin, and a distance from the destination. For example, moving the sliding scale to the right may indicate a high tolerance for change. Conversely, moving the sliding scale to the left may indicate that they have a low tolerance for change. Alternatively, sliding scale 410a may, for example, be used by the user device to indicate the user's tolerance for departing early, while sliding scale 410b may be used by the user device to indicate the user's tolerance for departing later than the date originally selected by the user device. While four sliding scales are illustrated for ease of illustration, it will be understood that the graphical user interface 400 may include any number of sliding scales to capture a range of preferences and tolerances.

The sliding scales 410a-420d may initially show no tolerance for changes, and the user device may adjust the sliding scales according to the user's preferences. The preferences may be captured by the user model in the user model database 320. Alternatively, the graphical user interface 400 may show the current preferences and tolerances drawn from the current user model associated with the user of the user device and allow the user device to tailor the tolerances for the current itinerary. For example, while the user's user profile may indicate that the user typically has a high tolerance for change, for a given trip, the user may have a low tolerance for changes and accordingly the user device may adjust the tolerances shown on the graphical user interface 400.

Boxes 420a-420d may be drop-down lists that may be used by the user device to indicate basic travel parameters. For example, the user device may select an origin from the drop-down list 420a and a destination from the drop-down list 420b. Drop-down boxes 420c-420d may be drop-down calendars, from which the user device may select a departure and a return date.

FIG. 4 illustrates an example graphical user interface. It will be understood that alternative user interfaces that are commonly known to those skilled in the art may be used. For example, tolerances and preferences may be hidden from the booking interface, and a separate user profile interface may instead be used. In such cases, the user profile interface may extract data from the user model database 320, third-party data storage models at the agency level, the corporation level, or via the common GDS profile data store to derive the user profile.

### Travel Itinerary-Changes Model Database

Referring back to FIG. 3, the travel itinerary-changes model database 322 may store itinerary change records generated in accordance with a model that represents travel itinerary changes. A travel itinerary changes model may be understood as an extension of conventional travel itinerary models, extended to include aspects related to changes to travel itineraries. Travel itinerary changes models may capture aspects of the travel itinerary booked by the user device and the implications of change requests on the travel itinerary. Each travel itinerary changes record in the itinerary changes model database 322 may be associated with an itinerary and may be populated with permitted changes to an itinerary.

Similar to the user models, the travel itinerary changes model may be implemented using any combination of approaches and technologies, including, but not limited to, relational databases, graph databases, key/value stores, document databases, and search engine indices.

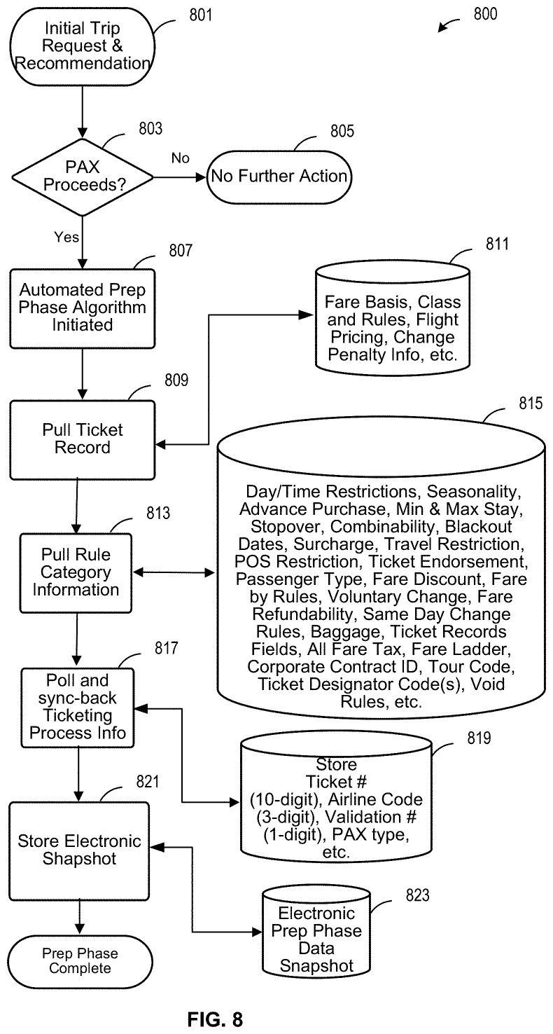

For example, the travel itinerary changes model may incorporate information that may impact itinerary changes, including, but not limited to, information relating to travel fares and tax ladders, rules associated with itinerary pricing, travel restrictions, day/time restrictions, seasonality information, blackout dates, and minimum and maximum stay information. In at least one embodiment, this information may be derived from the itinerary originally selected by the user device, as will be described in further detail with reference to FIG. 8.

In at least one embodiment, the travel itinerary changes model may capture the implications of change requests on a travel itinerary using itinerary change process flows. FIG. 5, which will be described in further detail below, illustrates an example process flow that may be contained within a travel itinerary changes model.

### Scheduler

The scheduler 324 can interface with the travel supply network 330 to determine available itineraries that meet the constraints established by the system 300 and by the user device. For example, the scheduler 324 may interrogate the travel supply network 330 to identify suppliers that can fulfill the potential changed itineraries responsive to the change request. The scheduler 324 may maintain a schema mapping between the itinerary, the user models, and the search APIs used to interface with suppliers. The schema mapping may connect the internal schemas maintained by the system 300 and the various external schemas supported by the travel suppliers in the travel supply network 330.

For example, potential changed itineraries may be retrieved from the travel supply network 330 using structured queries. Parameters for the queries may be provided by the optimizer 326, and the queries may be structured based on the schema mapping between the internal schema of the system 300 and external schemas used by the travel supply network 330.

In at least one embodiment, the scheduler 324 may also fulfill the original travel request. In response to receiving a travel itinerary request from a user device, the scheduler 324 may interrogate the travel supply network 330 to identify a set of travel itineraries that fulfill the travel itinerary request submitted by the user device.

In at least one embodiment, the scheduler 324 may also store data from the travel supply network 330 in the itinerary-changes model database 322 and user model database 320, including information related to the travel itinerary, and the parameters needed in the event that the itinerary needs to be changed at a later date, as will be described in further detail below, with reference to FIG. 8.

In at least one embodiment, the scheduler 324 may further interoperate with a booking system to purchase travel content. For example, the scheduler 324 may use the narrower set of itinerary-change parameters, derived by the optimizer 326 to evaluate itineraries for purchase. As the parameters may comprise more than one solution for itinerary changes, the scheduler 324 may return more than one itinerary for purchase. This list of potential itinerary changes may be transmitted to a user device that can present these options to travelers or their agents. Alternatively, under a fully automated mode, the system 300 may select the itinerary that is best aligned with the user preferences and transmit the itinerary to the user device, which may present the itinerary to a user who may approve or reject the changed itinerary. The rejection or approval may be transmitted by the user device to the system 300.

### Optimizer

The optimizer 326 may evaluate optimized tolerances for itinerary changes by evaluating whether future changes are feasible, and if future changes are feasible, identifying the range of parameters that optimizes a particular change to the itinerary against a stated goal, such as cost reduction.

The optimizer 326 may use one or more optimization methods that may be used individually or in ensembles. The optimizer 326 may use any type of optimization method capable of optimizing a particular change to an itinerary against a stated goal, including, but not limited to, machine learning based optimizations, statistical optimizations, decision-tree optimizations, or rule-based optimizations. The stated goal may be configured by the administrators of the change management system 300 or derived from the user model (e.g., depending on the user's preferences). For example, the optimization goal may be a reduction in costs or a minimization of delays.

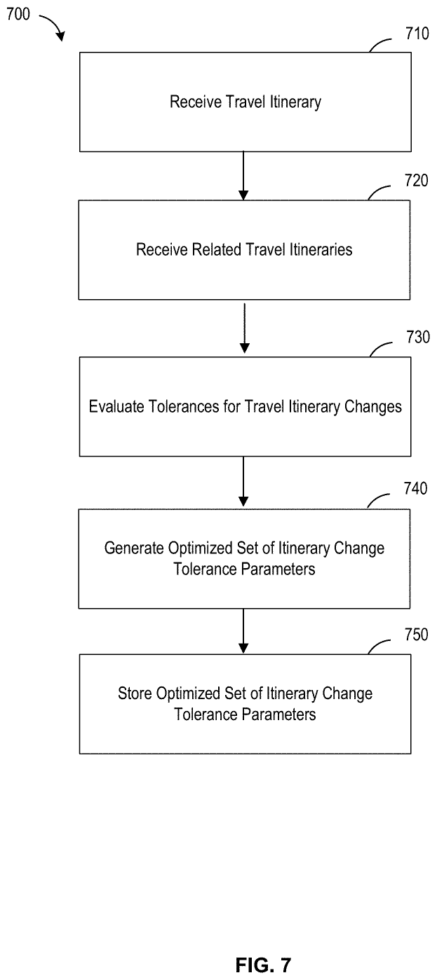

For any given travel request, there may be at least one (and often more than one) potential itinerary that satisfies the request. For example, for a flight to Miami from Detroit on a given date, there may be several flights that may be selected to satisfy that request. The traveler may have various preferences and tolerances with respect to the flight, such as preferring nonstop flights or flying only during the daytime, which may be captured in the user profile associated with the user. Further, the request may entail a number of allowable or permitted changes for any flight, depending on factors such as the fare basis or the cancellation insurance carried, which may be captured by the itinerary changes record associated with the itinerary. The optimizer 326 attempts to reconcile this array of considerations down to a narrower set of optimized itinerary-change parameters, as will be described in further detail with reference to FIG. 7. In some cases, feasible changed itineraries may be determined based on the optimized itinerary-change parameters.

While the space of itinerary changes may be very large, the space permitted by the constraints imposed by the initial travel request, the user profile associated with the user, and the travel itinerary changes record associated with the initial itinerary may be relatively narrow. When a change to the travel itinerary is requested, the narrow space of changes permitted by the constraints may be evaluated, rather than the space of all the unconstrained possible itinerary changes.

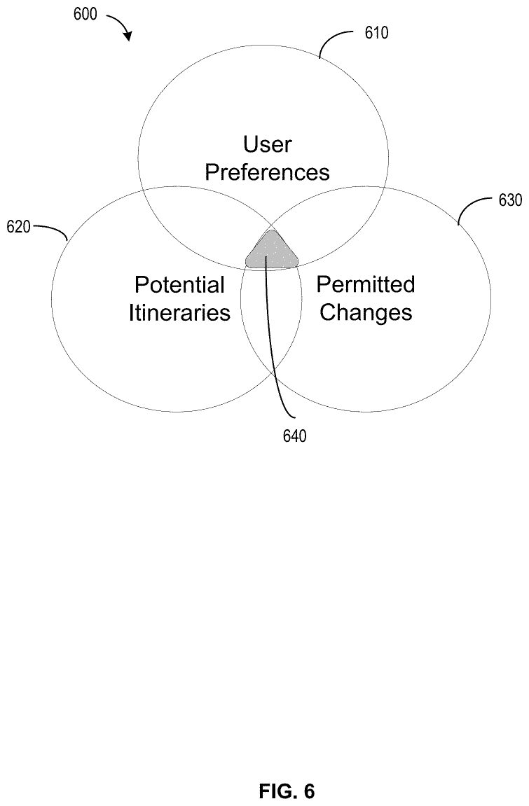

FIG. 6 shows an example diagram 600 illustrating the optimization problem solved by the optimizer 326. The optimizer attempts to find the solution that corresponds to the intersection 640 of the set of user preferences 610 as captured by the user profile associated with the user, the set of parameters associated with the potential itineraries 620, and the set of permitted changes to the travel itinerary 630, as captured by the itinerary changes record associated with the initial itinerary. The set of potential itineraries 620 corresponds to the unconstrained set of itineraries that satisfy the initial travel request. The solution corresponds to itinerary-change tolerance parameters.

The set of user preferences 610 and the set of permitted changes 630 may be expressed at least in part as tolerances to changes. In some cases, tolerances may be further categorized by facets, including, but not limited to, customer categories (e.g., frequent flyers), and by geographic regions. For example, specific changes may be permitted depending on the geographic region. In addition, tolerance parameters may be constrained by the travel suppliers, as expressed through their interfaces (e.g., through APIs). For example, certain travel suppliers may impose cancellation windows that may affect changes permitted to a travel itinerary.

Tolerances may be expressed using many forms and representations. For example, a tolerance related to a Yes/No decision may be expressed in binary terms; a tolerance that varies with the magnitude of the parameters, such as the price of a fare, may be expressed as a range of minimum and maximum relative (percentage) changes; a tolerance may be represented as a decision tree; a tolerance may be represented as a statistical model or probabilistic model, such as a distribution derived from past traveler choices. Such rules and models may be expressed in programmatic terms, applied against entities in the user model database 320 and itinerary-changes model database 322. It will also be appreciated that these tolerances may be acquired or derived over time, through machine learning models and data analyses, or crowdsourced through manual input of forms and data, as described above with reference to the user model database 320 of FIG. 3.

Referring back to FIG. 3, in at least one embodiment, the system 300 may store the logic necessary to efficiently make changes as an alternative to storing the changed itineraries that reconcile the user profile, the potential itineraries, and the itinerary changes record, which may reduce the amount of data stored.

In at least one embodiment, the optimizer 326 optimizes the itinerary-change tolerance parameters to obtain optimized itinerary change tolerance parameters that reduce costs. In at least one embodiment, to optimize the itinerary-change tolerance parameters with the goal to reducing costs, the system 300 tallies the costs associated with all itinerary-change tolerance parameters that carry a financial value into a credit account associated with the itinerary changes to rank the feasible itineraries associated with the itinerary change tolerance parameters. The financial values stored in the credit account may be used to determine and/or report the financial implications of itinerary changes to the user device and/or an agent device.

The credit account may be used to account for the financial implications of changes, and TMCs may use this information to provide additional services, such as to provide insurance for changes leveraged against these expected costs, or to conduct arbitrage with the differences between the expected and actual costs. Similarly, the actual costs or gains in realizing an itinerary change may be different than the range of costs associated with the itinerary-change budget, providing an additional source of revenue for the system administrators.

For example, during the initial booking stage, the cost of a final fare may be charged, taking into account the parameters and tolerances. A pending transaction with the airline may be generated, producing a precise pricing and ticket data transaction. If the user device requests an exchange, the estimated (or expected) exchange fees, as modeled by the system 300, and the actual exchange fees, may be compared. Discrepancies may be returned to the optimizer 326, to improve the future performance of the optimizer 326.

The results of these optimization evaluations may be stored in the event that future changes are required, such that if a change is later requested, the full range of itinerary choices need not be reviewed again, limiting the amount of data and transactions required between the user device and the travel suppliers. For example, Table 2 illustrates an itinerary change tolerance parameters table that captures example parameters that constitute optimized change tolerance parameters for a travel itinerary that may be used to derive a more complex search for booking the changed itineraries. In the example shown in Table 2, optimally, if the user device requests a change, an exchange should be initiated, and the changed itinerary should include a departure and return flight within the dates and times shown, while allowing the traveler associated with the user device to stay at the destination location for at least 2 days. The changed itinerary should not exceed $400.00, and the surcharge for exchanging the reservation should not exceed $50.00.

TABLE 2

| Itinerary Changes | Parameters |
|---|---|
| Exchange/Cancellation | E |
| Date Restriction | Jan. 1, 2022-Jan. 5, 2022 |
| Time Restriction | 05:00-08:00 |
| Min. Stay | 2 d |
| Surcharge | $50.00 |
| Base Fare | $400.00 |

If the optimizer 326 fails to reconcile the set of tolerances, there may not be feasible changed itineraries that are both permitted given the travel itinerary request and meet the user's travel preferences. In such cases, the system may transmit a notification to the user device that the given state of tolerances and available itineraries do not provide for an associated set of travel itinerary changes across all tolerance categories and accordingly, given the existing parameters, no changes may be made to the user's travel itinerary. The system may further transmit information to the user device regarding which tolerances are most problematic and suggest alternative parameters that would result in a solution to the optimization problem. The user device may then modify the tolerances, for example, via the graphical user interface 400.

In at least one embodiment, the optimizer 326 further identifies the one or more travel itineraries that satisfy the user device's change request, if they exist.

FIG. 5 shows a flowchart of an example method 500 of processing a change request that may be incorporated in the travel itinerary change models described above with reference to FIG. 3, and describes the type of information that may be required to process a change to an itinerary. The flowchart of method 500 shows a process flow for a post-booking change request to a flight, though it will be understood that the system 300 may receive change requests for other types of travel components, such as hotel changes or car rental changes. It will also be understood that various other process flows may be incorporated within the travel itinerary changes model.

By modeling this process flow, the travel itinerary changes model may anticipate the implications of various change requests that may be requested by the user. The process flow shown in FIG. 5 may be extended incrementally and include additional components as will be described below in relation to the system processing and with reference to FIGS. 7-9C.

At 501, the system receives a post-booking change request from the user interface 310, or through a cooperating travel reservation system 124. For example, a user may request a change in return flight.

At 503, the system determines the region of the request. If the region of the request is supported by the system, the method proceeds to 505. If the region is not supported by the system, the method ends, corresponding to a situation that cannot be accommodated by the system. Regionality may be relevant to fulfilling a change request as parameters such as cancellation windows, taxes, and exchange fees and penalties may vary based on region. In determining a region, the system may also retrieve parameters specific to the region, for example, cancellation windows, taxes, exchange fees, and penalties specific to the region.

At 505, the system determines the type of request. If the request is a pre-travel request, the method proceeds to 507. An example pre-travel request may include a change request that is received prior to a start of a trip associated with the travel itinerary. If the request is an in-travel request, the method proceeds to 529. An example in-travel change request may include a change request for a return flight after the traveler has departed from the traveler's origin.

At 509, the system determines whether the change request is requested within a predetermined cancellation window. The cancellation window may, for example, be a cancellation window negotiated or accepted by the traveler at the time of booking. A cancellation within the cancellation window may be associated with no cancellation penalties.

If the change request is placed within the cancellation window, the method proceeds to 511. Otherwise, the system determines whether a cancellation or an exchange is required. For example, a cancellation may be required despite the change request being made outside the cancellation window if the change requested by the user device is a cancellation. Alternatively, a cancellation may be required if the travel itinerary selected by the user device does not allow exchanges. The determination of whether the travel itinerary should be exchanged or canceled may be based on itinerary rules associated with the travel itinerary. If a cancellation is required, the method proceeds to 513. If an exchange is required, the method proceeds to 517.

At 511, the system cancels the travel itinerary, and a new itinerary is booked using an automated booking algorithm. The new itinerary may, for example, correspond to an itinerary identified at the time of booking, as described previously with reference to FIG. 3, or may be a new itinerary.

At 513, the system cancels the travel itinerary. The system may invoke an automated cancellation algorithm to cancel the travel itinerary.

At 517, the system initiates an exchange process. To determine a suitable exchange, the system may reference the electronic preparatory phase data snapshot 515, which may include information about itinerary rules, and about the user's travel itinerary, captured during the initial booking phase, as will be described in further detail with reference to FIG. 8.

At 519, the system stores the electronic credits obtained in exchange for canceling the travel itinerary. The electronic credits may be stored as structured credit tables in a database of stored credits 521.

At 523, the system determines if the user device has transmitted a request for a travel itinerary some time after canceling the previous travel itinerary. If the user device does not transmit a request for a travel itinerary within a pre-determined window of time, the method proceeds to 525 and the credits may expire. If the user device transmits a request for a travel itinerary within the pre-determined window of time, the method proceeds to 527.

At 527, the system initiates a booking sequence and applies the electronic credits by referencing the database of stored credits 521.

At 529, the system determines whether to cancel or exchange the travel itinerary. If the system determines that an exchange is preferable, the method proceeds to 531. If the system determines that a cancellation is preferable, the method proceeds to 533.

At 531, the system initiates an exchange process. To determine a suitable exchange, the system may reference the database 535, which may include information about itinerary rules and about the user's travel itinerary, as will be described in further detail with reference to FIG. 8.

At 533, the system cancels the travel itinerary. The system may invoke an automated cancellation algorithm to cancel the travel itinerary.

At 537, the system stores the electronic credits obtained in exchange for canceling the travel itinerary. The electronic credits may be stored as structured credit tables in a database of stored credits 539.

At 541, the system determines if the user device has transmitted a request for a travel itinerary some time after canceling the previous travel itinerary. If the user device does not transmit a request for a travel itinerary within a pre-determined window of time, the method proceeds to 543 and no further action is taken. If the user requests a travel itinerary within the predetermined window of time, the method proceeds to 545.

At 545, the system initiates a booking sequence and applies the electronic credits by referencing the database of stored credits 539.

### System Processing

FIG. 7 shows a flowchart of an example method 700 for (automatically) processing changes to travel itineraries. Method 700 may be implemented by system 300.

At 710, the scheduler 324 of the system 300 receives a travel itinerary. The travel itinerary may be responsive to a travel itinerary request. For example, the system 300 may receive a travel itinerary request from a user interface 310 that may be accessed by a user device. The scheduler 324 may then search a database of travel itineraries for travel itineraries that satisfy the travel itinerary request. In some cases, the database may be maintained by travel suppliers in the travel network. Accordingly, the scheduler 324 may generate a structured search request from the travel itinerary request. In some cases, the scheduler 324 may generate a structured search request from the travel itinerary request to directly query suppliers for itineraries that fulfill the travel request. A set of potential travel itineraries may be generated from the searched travel itineraries. In some cases, to identify potential travel itineraries, the scheduler 324 may retrieve the user profile associated with the user and the itinerary change record from the user model database 320 and the itinerary changes model database 322, respectively, to evaluate the request and identify travel itineraries that satisfy the traveler's preferences as captured by the user profile and/or that are likely to be modifiable at a later date. A travel itinerary may then be selected from the set of potential travel itineraries. For example, the system 300 may transmit a list of potential travel itineraries that fulfill the user's request to the user device, which may present the list via the user interface 310. The user device may receive a selection of a travel itinerary from the list of potential travel itineraries and transmit the selection to the system 300. Alternatively, the system 300 may recommend a travel itinerary using the user profile in the user model database 320 associated with the traveler and transmit the recommended travel itinerary to the user device. The user device may present the itinerary via the user interface 310 and receive an input from a user indicating an approval or rejection of the recommended travel itinerary. Alternatively, or in addition, the scheduler 324 may receive the travel itinerary from the user device.

In at least one embodiment, the scheduler 324 may capture information from the travel itinerary that may be used to update the user model and/or the user profile associated with the user and the travel itinerary changes record that may be used to select a changed itinerary if the user device later requests an itinerary change, as will be described in further detail with reference to FIG. 8. Alternatively, or in addition, the scheduler 324 may interact with the travel supply network 330 to retrieve itinerary information related to the travel itinerary.

At 720, the scheduler 324 receives travel itineraries related to the travel itinerary selected by, received from, or associated with the user device. For example, the scheduler 324 may search for related travel itineraries in the database of travel itineraries. As another example, the scheduler 324 may receive the related travel itineraries from the travel supply network 330. The related travel itineraries may be itineraries that satisfy the user device's travel request or that are substantially similar to the travel itinerary selected by, received from, or associated with the user device and may correspond to proposed itineraries encompassing a change request that may be received at a later time. For example, the related travel itineraries may include the set of potential travel itineraries described at 710.

At 730, the optimizer 326 evaluates tolerances for travel itinerary changes. The travel itinerary-change tolerance parameters may be obtained by resolving the set of permitted changes to an itinerary, related travel itineraries, and user preferences, for example, as described above with reference to FIG. 6. In evaluating tolerances for travel itinerary changes, the optimizer 326 may populate the itinerary changes model with permitted changes or receive permitted changes from the itinerary-changes model database 322. The permitted changes may define the set of allowable changes to the travel itinerary and/or rules associated with making changes to the travel itinerary, and may be based on information captured from the travel itinerary received at 710. The user preferences may include travel preferences of the user and parameters describing user tolerance to changes, in accordance with the user model.

Retrieving the related itineraries may involve retrieving a set of related itinerary parameters associated with the related itineraries, including the description of each related itinerary and the price associated with each related itinerary.

In at least one embodiment, the set of itinerary change tolerance parameters is obtained by intersecting parameters from the set of permitted changes, the set of related travel itineraries, and the set of user preferences. In some cases, feasible changed itineraries associated with the itinerary change tolerance parameters may be identified. To accomplish this, the optimizer 326 may resolve the intersection of the itinerary change parameters, the user preferences, and the related itineraries to evaluate the itinerary change tolerance parameters.

At 740, the optimizer 326 may generate an optimized set of itinerary change tolerance parameters based on the evaluated itinerary-change tolerance parameters obtained at 730.

During the optimization processes at 730 and 740, the optimizer 326 may evaluate whether changes are feasible given the preferences and tolerances stored in the user model and the itinerary change model and the potential itineraries. If the intersection of the permitted changes, the related travel itineraries, and the user preferences cannot be resolved, the system 300 may transmit an alert to the user device or to an agent device indicating that the itinerary selected will not be modifiable given the permitted changes and the user preferences of the user. If changes are feasible, the optimizer 326 may optimize the range of itinerary change tolerance parameters for a particular goal, such as cost reduction. The goal may be specified by the user device. Alternatively, the goal may be determined based on the user model or may be predetermined by the system 300. In at least one embodiment, the optimized itinerary change tolerance parameters may encode the logic necessary to make changes.

In at least one embodiment, the changed itineraries are ranked according to their cost and the optimized set of tolerance parameters may include ranked changed itineraries.

The pseudocode below describes an example method of generating an optimized set of tolerance parameters:
A: Retrieve the set of {itinerary-change parameters}, including:
   Length of cancellation-window;
   Change penalties;
   Refundability;
   Eligibility;
   Etc.
B: Retrieve set of {potential-itinerary parameters}, including:
   Set of flight options;
   Set of prices;
   Etc.
C: Retrieve set of {user-preference parameters}, including:
   Cheapest flight?;
   Same or higher class of service?;
   Tolerance for time/date adjustments;
      Generate set of changed-itineraries by intersecting parameters from sets {A, B, C}:

```
  Get itinerary-template;
    Generate changed-itineraries parameters;
  Return set of changed-itineraries parameters;
If intersecting itineraries from sets {A,B,C} is zero;
  Flag changes as insoluble;
  // end
Else
  Flag changes as soluble;
  Determine feasible changed-itineraries associated with the set of
  changed itineraries parameters;
  Normalize set of feasible changed-itineraries by cost;
  Sort feasible changed-itineraries by cost;
  Return set of optimized changed-itineraries;
  // end
```

In the above pseudocode, itinerary-change parameters correspond to permitted change parameters and change-itineraries parameters correspond to itinerary-change tolerance parameters.

The following is a solution to a simple optimization problem, applying the pseudocode method presented above.
On March 12, a traveler reserves a one-way economy flight between San Francisco and Miami, departing on August 8 at 12:55 PM. In the preparatory phase of the booking, the change management system retrieves the following sets of information.
   Set A: Itinerary-change parameters:
      Cancellation-window-range: 1 month before departure
      Change penalties: $50
      Refundability: Yes
      Eligibility: Yes
   Set B: Potential-itinerary parameters:
      Potential flights: 59
      Relative departure time: −5:55 hr to +11:04 hr
      Stops, 0, 1, 2+
      Price range: $278-$2160
      Purchase price: $335
      Class: economy, business
      Purchased class: economy
   Set C: User-preference parameters:
      Cheapest flight: Yes
      Same or higher class service: Same
      Tolerance for time/date adjustments: +/−4:00 hr
      Stops: 0
      Price tolerance: +20%
Intersecting these sets using a one-way flight itinerary template (Origin City->Stops->Destination) produces the following set of intersecting itinerary change tolerance parameters:
Cancellation penalty: <July 9: 0; =>July 9: $300
Relative departure time: −4:00 hr to +4:00 hr
Stops: 0
Purchase price tolerance: $17 ($335×20%−$50)

This reduced intersecting set of itinerary change tolerance parameters produces the following set of feasible changed-itineraries (departure time, price): {12:55, AA7354, $335}. Given the set of itinerary-change parameters A, the set potential-itinerary parameters B, and the set of user-preference parameters C, there is only a single flight that reconciles the constraints across all three sets. In such a case, the change management system may flag this flight as having insoluble changes, that is, there are no other flights available that would satisfy all the user's stated tolerances.

Given the insolubility of changes, the traveler updates their travel tolerances using, for example, the user interface slider as shown in FIG. 4, indicating their willingness to extend the travel times by +/−12:00 hr. The change management system reruns the optimization algorithm to produce the following set of feasible changed-itineraries: {7:30, AA2208, $280}, {12:55, AA7354, $335}. The change management system flags the itinerary-changes as soluble, that is, that future changes are possible within the stated constraints.

The change management system accordingly persists the following details of the itinerary-changes:
Window for changes within price tolerances: July 9
Departure window: 7:30 to 12:55
Relative price range: $280-$355
Additional feasible itinerary: {7:30, AA2208, $280}

In this example, the optimizer 326 returns a flag indicating that future changes are possible given the current state of tolerances, preferences, and potential itineraries. In at least one embodiment, the system 300 transmits a notification to the user device and/or an agent device indicating that changes are feasible and the nature of these changes. For example, the notification may include the itinerary change tolerance parameters, the optimized itinerary change tolerance parameters, the changed itineraries associated with the itinerary change tolerance parameters, and/or the optimized itinerary change tolerance parameters.

At 750, the optimizer 326 may store this optimized set of itinerary change tolerance parameters and, in some cases, the evaluated change tolerance parameters. In some cases, the optimizer 326 may additionally store feasible itineraries associated with the set of optimized itinerary change tolerance parameters. When the user later requests a travel itinerary change, the scheduler 324 may retrieve the optimized set of change tolerance parameters and/or the feasible itineraries to identify changed itineraries that fulfill the change request.

FIG. 8 shows a flowchart of an example method 800 of capturing information that may be used by the scheduler 324 during the initial booking stage. Method 800 corresponds to an example method of capturing information from a flight reservation, though it will be understood that similar methods may be used to capture information about other travel components, including but not limited to hotels and car rentals.

As described above with reference to FIG. 7, the scheduler 324 may capture information from the travel itinerary when the itinerary is received or when the itinerary is selected. The information captured may include information that may affect changes that can be made to the travel itinerary.

At 801, a travel request is received. For example, the travel request may be received from the user interface 310 of a user device, or through a cooperating travel reservation system 124. As described above at 710 in method 700, the travel request may be evaluated, and potential travel itineraries may be determined. A travel itinerary may then be selected and reserved by the reservation system 124 and/or by the user device via the user interfaces 110 from the set of potential travel itineraries. A ticket associated with the travel itinerary may be issued.

At 803, the system 300 determines whether a travel itinerary has been selected. If no travel itinerary has been selected, for example, no itinerary has been selected by the user device, the method proceeds to 805, and no further action is taken.

If the scheduler 324 determines that a travel itinerary has been selected, the method proceeds to 807 and the scheduler 324 enters an automated preparatory phase. During the preparatory phase, information related to the travel itinerary selected is captured. This information may be used in the itinerary changes model and the user model which can be used to expedite future changes to the travel itinerary.

At 809, the scheduler 324 captures the ticket record associated with the travel reservation. For example, the scheduler 324 may retrieve the ticket record from the travel supply network 330. The ticket record may be retrieved in a structured form from the global distribution system or from the specific supplier that supplied the travel reservation, such as an airline company.

The ticket record may include general information about the itinerary selected by the user, including, but not limited to, a fare basis, a class, rules and constraints associated with the fare basis and/or the class, pricing information, and information relating to penalties for changes as shown by container 811.

At 813, the scheduler 324 captures rule category information associated with the itinerary. Rule category information may correspond to rules associated with the travel itinerary that may affect changes possible to the travel itinerary and may be retrieved from the travel supply network 330, similar to the ticket record. Rule category information may be defined by the travel supplier supplying the travel itinerary component. Rule category information can include, but is not limited to: restrictions on a day and time of travel; seasonality (low, high, shoulder); advance purchase requirements; a minimum and maximum stay; stopover information, including whether stopovers are permitted and the maximum number of stopovers; combinability rules including rules for one way, round trip, and open jaw travel, and other rules for combining multiple fare bases; blackout dates where the fare is not applicable; surcharges for the fare; travel restrictions; sale restrictions on point of sale; ticket endorsement; passenger type (e.g., adult, child, infant, senior); fare discount (e.g., based on the passenger type); fare by rules (e.g., public, private, negotiated fares); rules for voluntary changes; fare refundability; same-day restrictions; baggage allowance; ticket record fields; tax information (as taxes may differ when an itinerary change is made); fare ladders (e.g., the impact on fares with changes in the lead time prior to departure); corporate contract information; tour code information; ticket designator codes; and void rules as shown by container 815.

At 817, the scheduler 324 captures information specific to the travel itinerary selected by the user and that may be required to identify the traveler when a change is later requested. This information may be referred to as ticketing process information. For example, a ticket number, an airline code, a store validation number, and a PAX type may be stored as shown by container 819.

Once the necessary information related to the travel itinerary is captured, the method proceeds to 821 and stores an electronic snapshot that contains the information captured at 809, 813, and 817 into the electronic preparatory phase data snapshot database 823, and signals that the preparatory phase is completed. In at least one embodiment, the electronic preparatory phase data snapshot is stored in the itinerary-changes model database as the itinerary changes record associated with the travel request. Additionally, any changes or updates to the user profile associated with the travel request may be stored in the user model database.

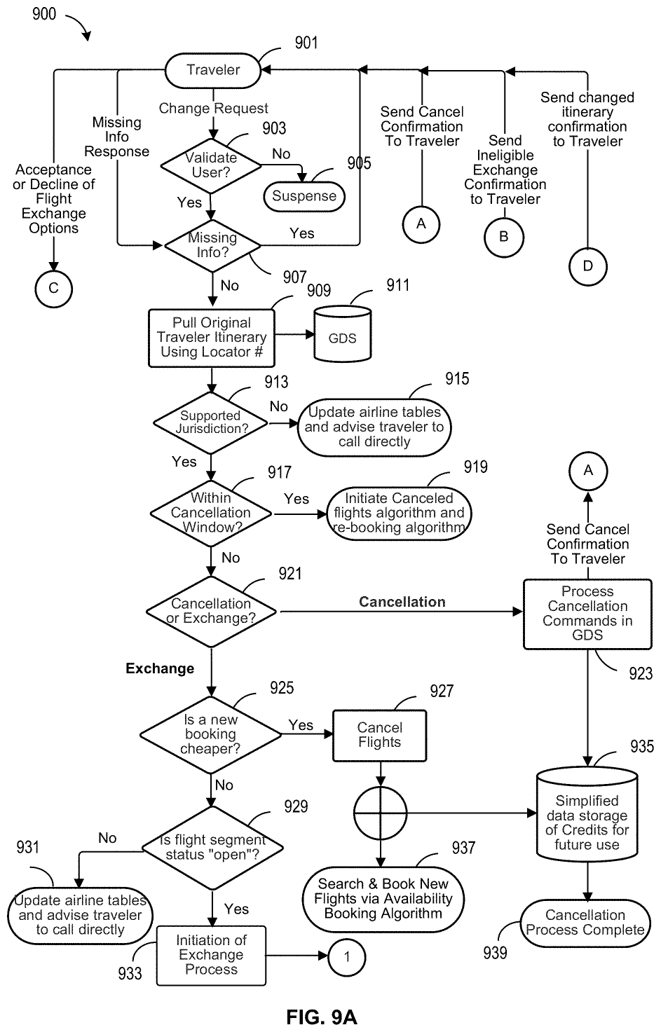

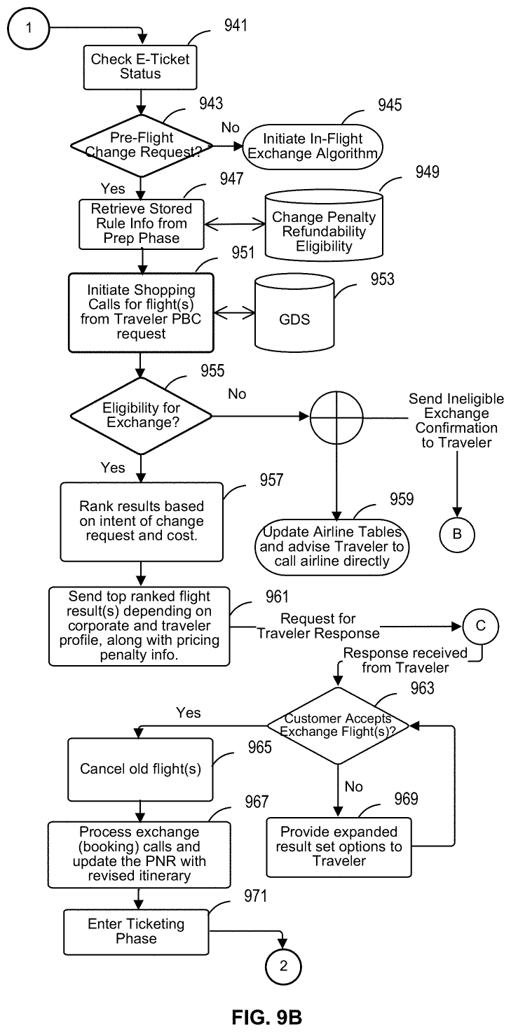

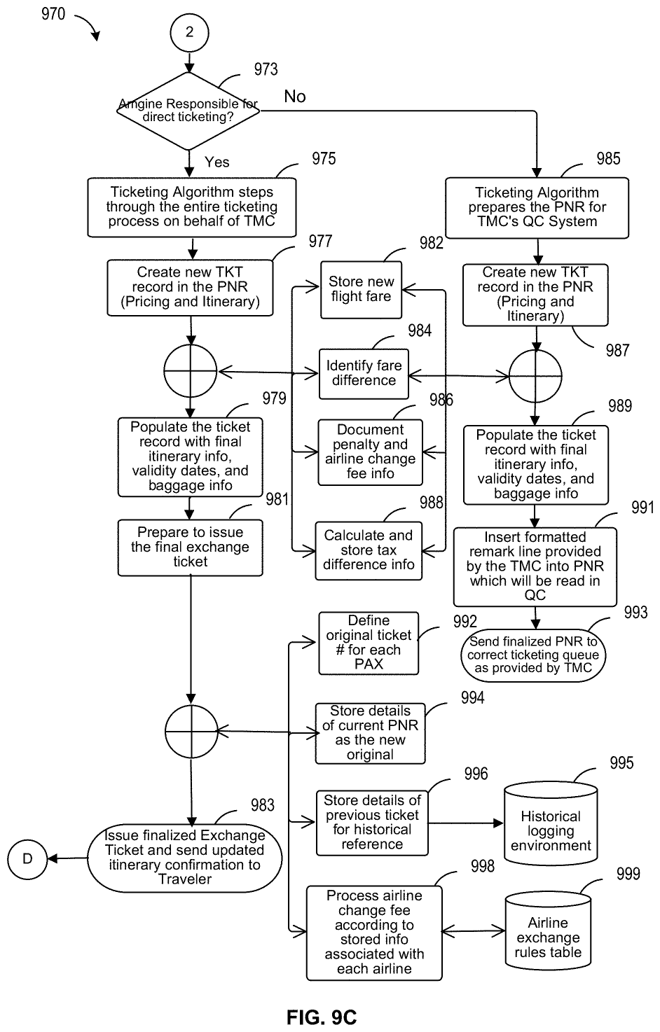

FIGS. 9A-9B show an example flow diagram of a method 900 of processing an itinerary change request that may be used by system 300 and/or travel network 100. Itinerary change requests can be (automatically) processed by the systems described herein, removing the need for manual processing of changes by a human agent.

At 901, the user interface 310, which may be implemented by a user device, or a cooperating travel reservation system 124 requests a travel itinerary change for a previously booked itinerary. Though the flow diagram shows a traveler requesting the change, it will be appreciated that the change is requested by a user device and can be requested by the user device associated with the traveler or by other user devices on behalf of the traveler, provided, for example, the requesting user device can provide information necessary to validate the traveler. For example, in some cases, an employer booking a trip for an employee may initiate a change request on behalf of the employee via a user device associated with the employer. The change request can include any requests for changes to an existing itinerary, including, but not limited to, a request to change a departure date of travel, a return date, an origin, and a destination.

At 903, the scheduler 324 validates the traveler to retrieve the locator number associated with the traveler's itinerary. If the scheduler 324 is unable to validate the user, the method proceeds to 905 and enters into a suspend mode. The suspend mode can correspond to a customer support queue that may require the intervention of an operator, such as a robot operator (e.g., a travel bot) or a human operator.

If the scheduler 324 can validate the traveler, the method proceeds to 907. At 907, the scheduler 324 determines if any information is missing. Missing information can include, for example, a lack of user preferences in the user profile associated with the traveler or an otherwise incomplete user profile or an incomplete change request that does not provide sufficient details about the change requested. If information is missing, the method returns to 901 to request additional information from the traveler's user device. Once additional information is provided by the user device, the method returns to 907.

If all the requisite information has been provided, the method proceeds to 909. At 909, the scheduler 324 retrieves the original travel itinerary associated with the traveler using the locator number associated with the itinerary. The locator number may be provided by the travel supply network 330 at the time of booking and stored with the original travel itinerary. Travel itinerary information can be retrieved from, for example, the GDS 911. Itinerary-change parameters associated with or based on the travel itinerary can also be retrieved from the itinerary change database (not shown) as described previously with reference to FIG. 3. Once itinerary details and itinerary change tolerance parameters are retrieved, the method proceeds to 913.

At 913, the scheduler 324 determines if the change of jurisdiction is supported. For example, a request to change a destination may fall outside the range of previously canvassed feasible itineraries, determined during the initial booking stage. The jurisdictions supported may be related to allowable changes relating to origin and destination pairs, as defined by the rule category information stored at the time of booking. For example, a request to change a domestic flight to an international flight may be unsupported. If the jurisdiction is not supported by the system 300, the method proceeds to 915.

At 915, the scheduler 324 may update airline flight information and advise the traveler to communicate with the airline directly. Updating the airline table flight information can allow the airline responsible for the flight to view that an out-of-jurisdiction change was unsuccessfully requested.

If at 913, the scheduler 324 determines that the jurisdiction is supported by the system 300, the method proceeds to 917. At 917, the scheduler 324 determines whether the change request occurs within a cancellation window. The cancellation window may, for example, be a previously negotiated cancellation window between the traveler and the travel supplier at the time of booking. If the change request is initiated within the cancellation window, the method proceeds to 919. If the change request is initiated outside the cancellation window, the method proceeds to 921.

At 919, the scheduler 324 cancels the original travel reservation and makes a new booking in accordance with the user's change request. For example, the scheduler 324 may transmit a cancellation request to the travel supplier that supplied the travel itinerary or to the GDS 911. The cancellation and new booking may be a conventional cancel-and-rebook process as known by those skilled in the art.

At 921, the scheduler 324 determines whether the change request requires a cancellation or an exchange. For example, the change request may involve a request to cancel a part of the itinerary. The system 300 may also use the itinerary changes parameters retrieved at 909 to determine whether the request requires an exchange or a cancellation. For example, the change requested may fall outside the range of previously canvassed feasible itineraries determined during the initial booking stage and, accordingly, the scheduler 324 may be unable to accommodate the change request and require a cancellation. If the scheduler 324 determines that a cancellation is preferable, the method proceeds to 923.

At 923, the scheduler 324 cancels the original travel reservation. The cancellation may, for example, be initiated by a cancellation command sent via the independent suppliers 132 to the GDS 134. The scheduler 324 may then send a cancel confirmation to the user device. The scheduler 324 may also trigger an update to a virtual crediting system 935 (e.g., a simplified data storage of credits for future use) that may be provided to the TMC to account for any differences between the previously budgeted changes and the actual costs incurred.

If at 921, the scheduler 324 determines that an exchange is preferable, the method proceeds to 925. At 925, the optimizer 326 determines whether, given the change request and the range of previously canvassed feasible itineraries, a cancellation and new reservation would be less costly than an exchange. For example, the optimizer 326 may evaluate the costs of the itineraries that satisfy the change constraints of the change request and evaluate the cost of a new itinerary that satisfies the change request, taking into consideration cancellation charges if applicable. If the optimizer 326 determines that a new reservation would minimize costs, the method proceeds to 927. If the optimizer 326 determines that a new reservation would not lead to cost savings, the method proceeds to 929.

At 927, the scheduler 324 cancels the original travel reservation. Similar to 923, the cancellation may be initiated by a cancellation command sent via the independent suppliers 132 or the GDS 134, and travel credits may be sent to the virtual crediting system 935 for future use. Once the original travel reservation has been canceled, the method proceeds to 937. The scheduler 324 may store in the system 300 or otherwise indicate that the cancellation process is complete 939.

At 937, the scheduler 324 initiates searches for a new itinerary and makes a new travel reservation for the traveler. In some cases, the scheduler 324 may forward the change request to a travel reservation system 124 that can process the change request as a new travel itinerary.

At 929, the scheduler 324 determines the status of the flight segment. If the flight segment is open, for example, if the flight segment is still electronically available for change, as determined by the airline, the method proceeds to 933. If the flight segment is not open, the method proceeds to 931.

At 931, the scheduler 324 updates airline flight information and provides a notification to the traveler's user device to advise the traveler to communicate with the airline directly.

At 933, the scheduler 324 initiates the exchange process.

At 941, the scheduler 324 checks the status of the traveler's electronic ticket. The status of the electronic ticket may indicate if changes can be made to the itinerary, the types or methods of change possible, and any other information affecting the validity of the ticket. For example, an open electronic ticket may indicate that changes to the ticket are still possible. Other ticket statuses may include restrictions on the types of changes possible, including an indication that the travel supplier must be contacted directly to modify an itinerary, or an indication that only in-person changes are available, or cutoff times for changes to a ticket. As ticket status may change rapidly, checking the status of the electronic ticket can ensure changes are only processed if permitted.

At 943, the scheduler 324 determines whether the request is a pre-flight change request. If the request is not a pre-flight change request, the method proceeds to 945. If the request is a pre-flight request, the method proceeds to 947.

At 945, the scheduler 324 initiates an in-flight exchange algorithm.

At 947, the scheduler 324 retrieves stored rule information from the previously calculated itinerary change tolerance parameters to identify itineraries amongst the previously canvassed feasible itineraries based on the change request. The scheduler 324 may change penalty refundability eligibility 949. Additionally, the scheduler 324 queries the independent suppliers 132 and/or GDS 134 to confirm that the previously canvassed feasible itineraries remain valid solutions to the change request.

At 951, the scheduler 324 initiates shopping calls to travel suppliers via, for example, the GDS 953 to identify travel suppliers that can fulfill the change request. For example, the scheduler 324 may identify travel suppliers that can supply the itineraries to fulfill the change request. If the scheduler 324 is unable to fulfill the request, for example, if no travel supplier can supply the itineraries that fulfill the change request, the system 300 may forward a failed request notification to an agent's computer terminal and/or to the user device for the traveler. For example, a previously canvassed flight that existed at the time of booking may no longer have available seats when the change request is initiated. The method then proceeds to 955.

At 955, the scheduler 324 determines whether the traveler's initial travel booking is eligible for an exchange. For example, the fare category selected by the traveler at the time of booking may preclude exchanges. If the travel booking is not eligible for an exchange, an ineligible exchange confirmation is transmitted to the user device for the traveler and the method proceeds to 959.

At 959, the scheduler 324 updates airline flight information and provides a notification to the user device for the traveler to advise the traveler to communicate with the airline directly. Similar to 915, updating airline table information may allow the airline to be notified that an exchange for a travel itinerary that is not eligible for exchanges was requested.

If at 955, the scheduler 324 determines that the travel booking is eligible for an exchange, the method proceeds to 957.

At 957, the optimizer 326 ranks the list of itineraries available determined at 951. The ranking may be based on the intent of the change request and the cost. In a general sense, the ranking may be based on the optimization goal. For example, itineraries may be ranked by cost. Once the itineraries are ranked, the method proceeds to 961.

At 961, the scheduler 324 transmits the top ranked results to the travel reservation system 124 or to the user device via, for example, the user interface and requests a response from the user. The ranking may be based on additional factors not included at 957, including corporate preferences, the traveler's profile, and/or pricing penalty information. The top 3 ranked results may be transmitted to the user device. The user may accept or decline the options presented by indicating such on the user device. Once a response is received from the user device, the method proceeds to 963.

At 963, the system 300 determines whether the user has accepted one of the candidate changes transmitted at 961. If the user has not accepted any of the candidate changes, the method proceeds to 969.

At 969, the scheduler 324 provides an expanded set of candidate changes to the user device. For example, the system may provide the full ranked list of itineraries determined at 957.

If at 963, the scheduler 324 determines that the user has accepted a candidate change, the method proceeds to 965. At 965, the scheduler 324 cancels the original travel reservation.

At 967, the scheduler 324 processes the exchange and updates the passenger name record (PNR) information with the revised itinerary.

At 971, the scheduler 324 initiates the ticketing phase.

FIG. 9C shows a flowchart of an example embodiment of a method 970 of preparing a ticket for the changed itinerary that may be used by the change management system 300 or a travel reservation system 124 associated with the change management system 300.

At 973, the scheduler 324 determines whether an internal or external booking engine is responsible for ticketing. If the platform is not responsible for ticketing, the scheduler 324 proceeds to 985. If the platform is responsible for ticketing, the method proceeds to 975, indicating that the scheduler 324 can generate a ticket on behalf of the TMC.

At 977, the scheduler 324 prepares a new ticket record in the passenger name record (PNR).

In preparing the new ticket record, the scheduler 324 may proceed to 982, 984, 986, and/or 988 to prepare records of the implications of the itinerary changes. At 982, the scheduler 324 stores the new flight fare. At 984, the scheduler 324 calculates a fare difference between the new itinerary and the original itinerary. At 986, the scheduler 324 determines penalties or fees incurred in changing the itinerary. At 988, the scheduler 324 calculates and stores any differences in taxes 988.

In at least one embodiment, the scheduler 324 compares the actual implications of the travel itinerary change to the expected implication of these changes, determined during the initial booking stage and/or captured by the itinerary changes model. Differences may be sent to the user device or to the TMC's computer terminal. The TMC, for example, may choose to pre-charge the traveler based on an initial insurance rate provided to the user at the time of booking. This rate may be adjusted depending on the actual changes made to the itinerary. Alternatively, the TMC may absorb any discrepancies between the initial insurance rate and the actual rate.

At 979, the scheduler 324 populates the ticket record with information related to the itinerary, the validity dates of the itinerary, and information relating to the user's baggage.

At 981, the scheduler 324 prepares itself to issue the ticket exchange. In preparing to issue the ticket exchange, the scheduler 324 may proceed to 992, 994, 996, and/or 998. At 992, the system defines the original ticket number for each PAX or passenger. At 994, the scheduler 324 replaces details of the passenger record with the current passenger name record (PNR), if applicable. At 996, the scheduler 324 stores details of the previous ticket for historical reference. For example, details of the previous ticket may be stored in a historical logging environment database 995 (e.g., that logs historical information) that may be external to the system 300 and accessed by the scheduler 324. At 998, the scheduler 324 processes the airline change fee according to stored information associated with each airline. For example, airlines may provide a schedule of fixed change fees, depending on a destination and a time of request. The scheduler 324 may retrieve change fee information from an airline exchange rules table database 999. The airline exchange rules table database 999 may provide change fees in the form of an exchange rules table.

At 983, the scheduler 324 issues the ticket and transmits a confirmation to the user device that the exchange has been completed.

At 985, the scheduler 324 prepares a passenger name record (PNR) for the TMC.

At 987, the scheduler 324 creates a new ticket record in the passenger name record (PNR). Similar to 977, in preparing the new ticket record, the system may proceed to 982, 984, 986, and/or 988. At 982, the system 300 stores information about the new flight fare. At 984, the scheduler 324 calculates differences in fares. At 986, the scheduler 324 identifies and documents any penalty or fee incurred for changing the user's itinerary. At 988, the scheduler 324 calculates and stores tax difference information.

At 989, the scheduler 324 populates the ticket record with information related to the itinerary, the validity dates of the itinerary, and information relating to the user's baggage.

At 991, the scheduler 324 inserts a remark line provided by the TMC into the passenger name record (PNR).

At 993, the scheduler 324 sends the passenger name record (PNR) to the TMC. For example, the scheduler 324 may transmit the passenger name record (PNR) to a ticketing queue provided by the TMC.

While the applicant's teachings described herein are in conjunction with various embodiments for illustrative purposes, it is not intended that the applicant's teachings be limited to such embodiments as the embodiments described herein are intended to be examples. On the contrary, the applicant's teachings described and illustrated herein encompass various alternatives, modifications, and equivalents, without departing from the embodiments described herein, the general scope of which is defined in the appended claims.

1. A system for processing changes to travel itineraries comprising:
at least one database for storing travel itineraries, traveler preferences, and itinerary change parameters;
a scheduler for exchanging information with one or more travel supply networks and operable to:
receive a travel itinerary; and
receive related travel itineraries; and
an optimizer operable to:
evaluate travel itinerary change tolerance parameters associated with the travel itinerary based on the traveler preferences, the itinerary change parameters, and the related travel itineraries;
generate an optimized set of itinerary change tolerance parameters based on the evaluated itinerary change tolerance parameters and an optimization goal; and
store the optimized set of itinerary change tolerance parameters for updating the travel itinerary.
The system of claim 1, wherein the travel itinerary is responsive to a travel itinerary request.

2. The system of claim 1, wherein the traveler preferences comprise traveler itinerary change preferences.
The system of claim 1, wherein the scheduler is further operable to search the database for the related travel itineraries.

3. The system of claim 1, wherein the scheduler is operable to receive the related travel itineraries from the one or more travel supply networks.
The system of claim 1, wherein the scheduler is further operable to identify changed itineraries based on the optimized itinerary change tolerance parameters.
The system of claim 6, wherein the optimizer is operable to rank each itinerary in the set of changed itineraries based on the optimization goal.
The system of claim 1, wherein the scheduler is further operable to:
receive a travel change request;
retrieve the travel itinerary;
retrieve the optimized set of itinerary change tolerance parameters associated with the travel itinerary;
identify a set of changed itineraries associated with the itinerary change tolerance parameters, based on the travel change request;
initiate a shopping call to the one or more travel supply networks to fulfill the set of changed itineraries; and
identify available changed itineraries within the set of changed itineraries based on a response to the shopping call from the one or more travel supply networks.
The system of claim 8, wherein the optimizer is further operable to:
rank the available changed itineraries based on at least one of: the travel change request or pricing information;
transmit the ranked available changed itineraries; and
receive a selection of a selected changed itinerary from the available changed itineraries.
The system of claim 8, wherein the scheduler is further operable to:
determine a geographical region of the travel change request;
determine if the geographical region is an allowable geographical region; and
when the geographical region of the travel change request is not an allowable geographical region, transmit an alert indicating that the travel change request cannot be fulfilled.
The system of claim 10, wherein the scheduler is further operable to:
retrieve at least one change implication associated with the geographical region from the database, the at least one change implication being selected from the group consisting of: a cancellation window, an exchange fee, an exchange penalty, and taxes.
The system of claim 8, wherein the scheduler is further operable to:
determine if the travel change request is received prior to a start of a trip associated with the travel itinerary; and
when the travel change request is not received prior to the start of the trip, transmit an alert indicating that the travel change request cannot be fulfilled.
The system of claim 8, wherein the scheduler is further operable to:
determine if the travel change request is received within a predetermined allowable cancellation window; and
when the travel change request is received within the predetermined allowable cancellation window, transmit a request to the one or more travel supply networks to cancel the travel itinerary.
The system of claim 1, wherein the optimizer is further operable to:
determine a feasibility of travel itinerary changes based on the evaluated travel itinerary change tolerance parameters; and
transmit a notification comprising at least one of: the feasibility of the travel itinerary changes, the travel itinerary change tolerance parameters, or the optimized set of travel itinerary change tolerance parameters.
The system of claim 1, wherein the travel itinerary is associated with a ticket record, rule category information, and ticketing process information.
The system of claim 15, wherein the rule category information comprises at least one of: date restrictions, time restrictions, rules relating to allowable changes based on fare bases, fare seasonality information, advance purchase information, a minimum stay, a maximum stay, stopover information, rules for combinability, blackout dates, data relating to surcharges, data relating to restrictions, ticket endorsement information, sale restrictions, a passenger type, a fare discount, fare rules, rules for voluntary changes to an itinerary, fare refundability rules, same day change rules, baggage information, combinability, ticket record fields, ticket endorsements, a fare tax, a fare ladder, a corporate contract ID, a tour code, tax information, a ticket designator code, or void rules.
The system of claim 15, wherein the scheduler is further operable to determine the itinerary change parameters based on the travel itinerary.
The system of claim 1, wherein the optimizer is operable to resolve an intersection of the itinerary change parameters, the traveler preferences, and the related itineraries to evaluate the itinerary change tolerance parameters.
The system of claim 1, wherein the traveler preferences comprise at least one of: a price preference, a preferred departure time, a preferred return time, a preferred class of service, a tolerance for changes in departure date, a tolerance for changes in departure time, a tolerance for changes in return date, or a tolerance for changes in return time.

4. A method for processing changes to travel itineraries, the method comprising:
receiving a travel itinerary;
receiving related travel itineraries;
evaluating travel itinerary change tolerance parameters associated with the travel itinerary based on traveler preferences, itinerary change parameters, and the related travel itineraries;
generating an optimized set of itinerary change tolerance parameters based on the evaluated travel itinerary change tolerance parameters and an optimization goal; and
storing the optimized set of itinerary change tolerance parameters for updating the travel itinerary.
